(19) United States
(12) Patent Application Publication
(10) Pub. No.: US 2025/0156755 A1
(43) Pub. Date: May 15, 2025

(54) Method and Device Allowing Identification of Systematic Errors in a Data-Based System Model

(71) Applicant: Robert Bosch GmbH, Stuttgart (DE)

(72) Inventor: Matthias Woehrle, Bietigheim-Bissingen (DE)

(21) Appl. No.: 18/833,128

(22) PCT Filed: Jan. 31, 2023
(86) PCT No.: PCT/EP2023/052283

§ 371 Date: Jul. 25, 2024

(30) Foreign Application Priority Data
Feb. 2, 2022 (DE) 10 2022 201 113.9

(51) Int. Cl. G06N 20/00

(52) U.S. Cl. CPC G06N 20/00

(57) ABSTRACT

A method for training a data-based system model includes (i) providing training data sets for training the system model, wherein the training data sets each comprise an input data set and a label, (ii) training the system model using at least some of the training data sets, (iii) executing a method for clustering data points in the input data sets in order to obtain data point clusters, (iv) determining a cluster model quality for each cluster, wherein the cluster model quality indicates an accuracy of the trained system model at the cluster data points with regard to the label assigned to the data points, (v) depending on the cluster model quality of each cluster, providing additional training data for the relevant cluster, and (vi) further training the system model using the additional training data.

### TECHNICAL FIELD

The invention relates to a method for analyzing a training state of a data-based system model, in particular locating systematic modeling errors in areas of the input data space of the training data used.

### TECHNICAL BACKGROUND

Sensors to record physical parameters are often continuously scanned. For example, a pressure, mass flow, acceleration, temperature, vibration, acceleration, or the like may be detected using a suitable sensor. At the output of the sensor or sensor system, a signal time series is then usually available as an electrical or digitized signal at predetermined sampling times. Said series indicates a temporal progression of a sensor signal in the form of a signal time series.

For evaluation, such a signal time series can be analyzed, in particular in an evaluation time window with a finite number of values, so that special features of a technical system can be detected based on the progression of the sensor signal. While the sensor signals can be evaluated in a variety of ways, one possible application is determining a time of a significant change in a system state (also referred to as a change point time) by evaluating the signal time series. To this end, a system model is usually provided, which assigns information to a cut-out of the signal time series indicating a change point time.

### DISCLOSURE OF THE INVENTION

According to the invention, a method for training a data-based system model, in particular for analyzing a training state of a data-based system model, is provided for locating areas of systematic modeling errors in the input data space of the trained system model according to claim 1, as well as a corresponding device according to the subordinate claim.

Further embodiments are specified in the dependent claims.

According to a further aspect, a method for training a data-based system model is provided, comprising the following steps:
providing training data sets for training the system model, wherein the training data sets each comprise an input data set and a label;
training the system model using at least some of the training data sets;
executing a method for clustering data points in the input data sets in order to obtain data point clusters;
determining a cluster model quality for each cluster, wherein the cluster model quality indicates an accuracy of the trained system model at the cluster data points with regard to the label assigned to the data points of the input data sets;
depending on the cluster model quality of each cluster, providing additional training data for the relevant cluster;
adapting the system model using the additional training data, in particular using further training.

As described above, the above method relates to a data-based system model provided as a neural network or as a data-based probabilistic regression model for evaluating input data sets that are high dimensional and that may comprise, for example, a signal time series of, for example, a conventional sensor that is continuously sampled in scanning steps. Such a sensor can be, for example, a pressure sensor, a mass flow sensor, an acceleration sensor, a vibration sensor, a radiation sensor, or the like. In order to monitor a change over time, such sensors are usually sampled continuously over time at a predetermined sampling frequency, and thus a signal time series is provided in an analog or digitized manner. Such a signal time series can be evaluated in a variety of ways.

In order to monitor system states, it is often necessary to detect a time point at which a significant state change occurs in the technical system to be surveyed. Such a time point is called a change-point time.

A group of data-based system models has proven itself in particular for evaluating a signal time series to determine a change-point time. To this end, the sensor signal is sampled, and a time period for the sensor signal is selected via an evaluation time window. The section of the sensor signal detected within the evaluation time window is supplied to the system model as a signal time series of an input vector.

The system model may be configured as a data-based model, such as in the form of a regression model or a classification model, such as a neural network, such that, depending on the input data set, a model output is output in the form of an output value or an output vector. If an output vector is output, it can be configured as a classification vector. This classification vector typically features dimensionality, with a number of elements each being associated with a class and each being associated with a given point in time within the evaluation window of the signal time series. The argmax of the classification vector corresponds to the classification to be determined, i.e., the index value of the relevant element in the output vector corresponds to a certain previously specified time within the evaluation window. The system model can thus be designed to indicate the change point time as a classification vector, wherein the change point time is indicated as argmax of the classification vector.

By using the system model as a classification model, a signal time series can be classified and, according to a trained system model, a change point time in the signal time series can thereby be determined within the selected evaluation signal window. The value for the classification vector element, i.e., typically the element having the highest value, then has an index value that determines the time in the signal time series corresponding to the change point time.

Training such a data-based system model is typically performed preferably using predetermined training data sets in an inherently known manner, in particular using gradient-based methods. The training data sets assign a classification vector as a label to an input data set, which preferably comprises the signal time series that can be obtained by sampling a sensor signal within a predetermined evaluation signal time window.

Training data sets are typically provided by measuring a technical system on a test bench, wherein in the case outlined above, a measured or otherwise determined change point time or other information can be assigned as a label to the signal time series as part of the input data sets. In so doing, the technical system is operated with different operating parameters to vary the training data sets within the possible input data space. This is intended to achieve the maximum possible coverage of the possible input data space. In reality, however, the input data space is only covered in areas that may be approached in a predetermined manner when measuring the technical system. Thus, the training data sets are not equally distributed throughout the theoretically possible input data space, so that a system model trained with the training data sets can systematically have a poorer evaluation in certain areas of the input data space. Furthermore, the model evaluation and/or the classification task can be more difficult in different areas of the input data space, e.g., due to greater noise and therefore more training data are necessary in these areas in order to be able to train a robust classifier there.

In accordance with the above method, a system model is first trained with the training data sets provided. The training data sets include, as described above, input data sets comprising the signal time series and which may further include one or more state variables of the technical system that affect the behavior of the system. The training data sets are each provided with a label that corresponds to a single value or multiple values or an output vector, which can correspond to a classification vector, for example, as described above.

The input data sets of the training data sets are then clustered using a suitable clustering method. The clustering method may be performed on data points of the input data sets determined at least by the at least one signal time series of the input data sets. The clustering method may be performed to create a number of clusters, each with a minimum size of training data sets. A cluster model quality is determined for each of the determined clusters. The cluster model quality evaluates the deviations of the model outputs of the trained data-based system model for the input data sets assigned to the cluster and the corresponding labels of the respective input data sets. For example, the cluster model quality may be determined based on an average value or median value of the variations, differences, or distances between the respective model outputs of the trained data-based system model for the input data sets assigned to the cluster and the corresponding label of the respective input data sets or based on an application-specific loss function as used for training.

Depending on the cluster model quality, a systematic modeling error (for low cluster model quality) may be detected for a corresponding cluster or area of the input data space determined by the relevant cluster of the input data sets. If it is determined that the cluster model quality for a certain cluster is not sufficient, e.g., by comparing a threshold value with a predetermined quality threshold, further training data sets may be determined for the corresponding area of the input data space to improve the cluster model quality of the system model in the area of the input data space of the cluster.

Clustering may generally be based on conventional clustering methods that do not require a specified number of clusters. Clusters are to be detected in which each data point of an input data set has a distance to data points of a number of k nearest neighboring input data sets of the training data sets that is less than a predetermined maximum distance. The maximum distance may be determined depending on a distribution density of the data points within the input data space.

In addition to clusters of data points for multiple training data sets, such clustering may also be used to form smaller clusters that only contain a single or a few data points. In principle, however, only those clusters whose number of data points from input data sets is less than a predetermined minimum number are considered clusters according to the above method.

It can be provided that the training data sets are partitioned, wherein the clustering method is performed on the partitioned training data sets separately, wherein in particular partitioning is performed depending on at least one state variable in the input data sets, wherein partitioning is performed with respect to predetermined value ranges of the at least one state variable and/or the label.

For the performance efficiency of the clustering method, it has been best practice to partition the input data space of the data points from the training data sets with regard to the one or more state variables that are not part of the at least one signal time series within the input data set of the training data sets. These are divided into predetermined value ranges to thus divide the amount of training data sets into partitions. The training data sets in the respective partitions may now be searched separately for clusters of the predetermined minimum size using an appropriate clustering method. The above method of determining cluster model quality is now performed separately in all partitions.

For example, to perform clustering, a neighborhood graph of the data points of the input data sets of the training data sets may be created using a predetermined distance metric (L2 norm or the like). In this case, the degree of proximity can be defined as a simplistic complex and edge weightings can be renormalized. For renormalization, for example, the distance do to the nearest neighbor is determined and all further neighbors are normalized with this distance, e.g., r=e\hat{ }(−((dk−d0)/sigma))), wherein sigma is a predetermined function based on the variance of the distances and dk corresponds to the distances to the nearest neighbors (index value k). Based on the neighborhood graph, a minimum spanning tree of the neighborhood graph can first be determined using an approach for evaluating the edges of the neighborhood graph. Subsequently, edges with the least edge weighting are iteratively removed, as may be provided in the HDBSCAN method as a possible clustering method. The HDBSCAN method may be adjusted by taking into account/eliminating only the weakest k edge connections and aborting the method at a maximum number of clusters found.

When selecting and configuring/parametrizing the clustering method, it is essential that clusters are detected as separate clusters even if there are individual data points between the clusters that may potentially connect the clusters to a common cluster. However, these should be left unconsidered or eliminated in the clustering process.

Alternative clustering methods may also represent other single linkage-based clustering methods or expectation maximization-based approaches or the like.

The core of the clustering methods to be used is to detect clusters of significant size, i.e., with a number of data points of the training data sets greater than the predetermined minimum number, without isolated training data sets outside the clusters found disrupting the separation of the individual clusters.

### BRIEF DESCRIPTION OF THE DRAWINGS

Preferred embodiments are described in more detail below with reference to the accompanying drawings. Shown are:

FIG. 1 a test bench for measuring a technical system and determining a data-based system model; and

FIG. 2 a flowchart illustrating a method for creating a system model.

### DESCRIPTION OF EMBODIMENTS

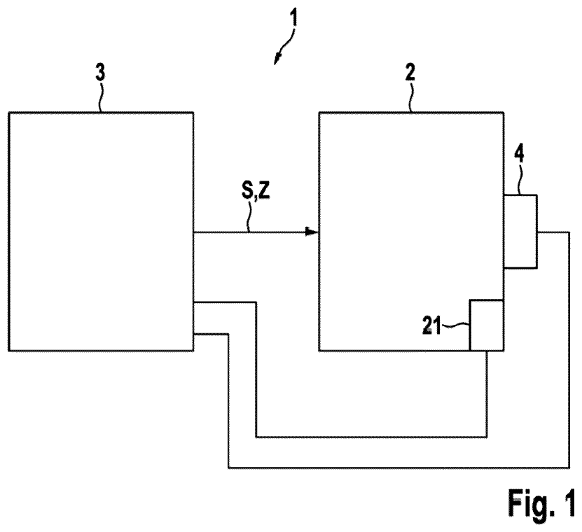

FIG. 1 shows a schematic representation of a test bench 1 for measuring a technical system 2 with a test bench unit 3 for determining training data sets. The test bench unit 3 operates the technical system 2 by creating temporal curves of one or more control variables S and, if necessary, by defining at least one state Z, such as by setting an ambient temperature. The technical system 2 comprises one or more sensors 21 and/or is provided with one or more additional sensors 4 to detect one or more sensor sizes.

A data-based system model is to be provided in order to assign at least one temporal curve of the one or more control signals, optionally the at least one state of the one or more sensor variables, so that the provision of the one or more sensors 21 and/or the one or more additional sensors 4 can be omitted.

On the test bench 1, the technical system 2 is measured by specifying temporal curves of the one or more control variables and the corresponding signal time series of the one or more control variables are assigned to a label that should correspond to the sensor variable. In this way, training data sets are determined that are assigned a label to a corresponding input data set from the one or more signal time series and the at least one measured variable.

The training data sets are used accordingly to train a system model that can provide the sensor variable in the sense of a virtual sensor or provide a control variable for controlling an actuator of the technical system 2.

When determining the training data sets, the input data space (usually the bounding box) of the data points (training data set without label, input data set) of the training data sets may not be evenly distributed due to systematic errors, and systematic errors may also occur depending on the area, which tend to lead to a model output that deviates from the labels of the training data sets. When providing the training data sets, it is therefore necessary to recognize these areas and, if necessary, to improve the coverage of the input data space by specifically providing further training data sets in the correspondingly identified areas of the input data space in which a systematic error has been detected. For this purpose, the amount of training data sets is successively increased, in particular in areas of the input data space in which a systematic error of the trained system model has been detected.

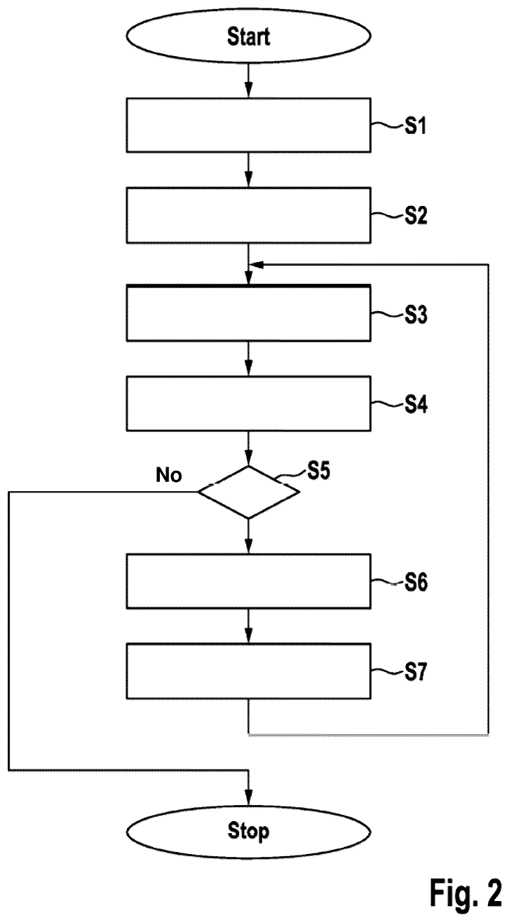

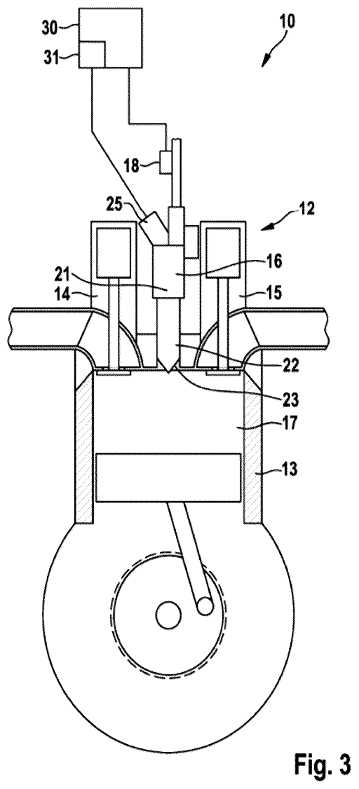

The method for determining areas of the input data room with systematic errors is described in more detail below using the flowchart of FIG. 2. The method may be performed as far as possible in a conventional data processing device and preferably implemented in the form of a software algorithm.
In step S1, the technical system 2 is first measured on the test bench 1 in order to obtain a number of training data sets, the input data sets of which are each assigned to a label. The input data sets include at least one signal time series corresponding to the course of a control magnitude or a sensor magnitude of the technical system 2. The label may comprise a single value, a value vector, or other form of output data. The measurement is preferably carried out in such a way that a wide spread of the input data sets can be achieved in the possible input data space with regard to the variation of the operating states.
In step S2, the data-based system model, which may be configured, for example, as a neural network or as a data-based regression model, for example as a Gaussian process model, and may be determined in the form of a regression or classification model, is trained with the training data sets.
In step S3, the input data sets are now clustered in order to obtain clusters of a predetermined minimum size, wherein the clusters are configured such that the data points formed by the input data sets are not interconnected by areas of individual or few data points. In other words, the clusters are determined by the density of the data points. High density areas of the data points form the clusters separated from each other by lower density areas of the data points.

Various methods may be considered as clustering methods. In the clustering method, only clusters in which the number of considered data points exceeds a predetermined minimum number are determined. The clusters are determined by the density of the data points in the input data space. Depending on the average density of the data points, higher density areas are determined, separated from each other by the lower density areas.

By way of example, the following method may be used as the clustering method. Depending on a predetermined distance metric (e.g., L2 norm), neighborhoods of the data points are evaluated and a neighborhood graph is created. For this purpose, the edges connecting two data points are provided with an edge weighting determined by the distance metric. A minimum spanning tree is determined from the neighborhood graph. In order for individual data points of the input data to be disregarded, a renormalization of the edge weighting in the neighborhood tree can be carried out according to the density of the data points in the corresponding area of the input data space. Subsequently, successive edges are removed from the minimum spanning tree. In particular, single linkage clustering methods such as HDBSCAN, which are known from the prior art, are suitable for this purpose. This ensures that only data points in which the density of the data points is sufficiently high are combined into clusters. The clustering method may be aborted or terminated upon reaching a predetermined maximum number of clusters.

Advantageously, the clusters may be made in a partitioned input data space, which is partitioned into multiple areas with regard to the at least one state variable. For this purpose, the at least one state variable can be divided into areas that correspond to value ranges of the same size or are defined by the same numbers of training data sets that are assigned to the respective area. The value ranges can alternatively also be determined by expert knowledge.

The clustering method described above may now be applied to the data points of the input data sets, wherein the data points are formed by the entire elements of the input data sets or the input data sets reduced by the at least one state magnitude.

Conventional clustering methods that take into account the distribution density of the data points can be used as clustering methods. In particular, the clustering method may be performed based on a neighborhood graph in which the edge weighting corresponding to the distance metric depends on the local distribution density of the data points. For example, the edge weighting may be determined from normalized distances to the nearest neighbors. Thus, for example, the edge weightings may be determined based on the ratio to the distance do to the nearest neighbor, for example using an exponential function e\hat{ }(−((dk−d0)/sigma))), wherein dk is the distance to the kth neighbor and sigma is a function based on the variance of the neighborhood distances. By removing lower density edges, partial graphs are formed, each forming a cluster to be determined. Other clustering methods, such as single linkage-based clustering methods or expectation maximization-based approaches, are also applicable.
The mapping accuracy of the data points in the clusters found in this manner can now be evaluated in step S4 according to the training data sets assigned to them in the form of cluster model quality. The cluster model quality may result as an average value or median value of the differences between the model outputs of the data points of the training data sets of the cluster to be evaluated and the labels determined by the corresponding training data sets.
In step S5, it is checked for each cluster whether the cluster model quality indicates a deviation above a predetermined quality threshold value. If this is the case for at least one of the clusters (alternative: yes), a systematic error is detected for the training data sets of the relevant cluster and the method is continued with step S6. Otherwise (alternative: no), the method is ended.
In step S6, further training data sets may be determined for the areas of the input data space determined by the clusters whose associated cluster model quality exceeds a predetermined quality threshold value and thus indicates a low mapping accuracy, in order to improve the cluster model quality of the system model in the relevant identified area of the input data space (cluster).
In step S7, the system model may be further trained with the further training data sets. In this way, the data-based system model may be purposefully improved and systematic errors eliminated or reduced. The method then continues in step S3.

Alternatively or additionally, the training data sets of the relevant cluster (with low mapping accuracy) may be considered when partitioning the data accordingly into training data and validation data.

FIG. 3 shows, as an example of a technical system 2, an injection system 40 for an internal combustion engine 12 of a motor vehicle, for which a cylinder 13 (of in particular several cylinders) is shown by way of example. The internal combustion engine 12 is preferably configured as a direct-injection diesel engine but may also be provided as a gasoline engine.

The cylinder 13 has an intake valve 14 and an exhaust valve 15 for supplying fresh air and for exhausting combustion exhaust gas.

Furthermore, fuel for operating the internal combustion engine 12 is injected into a combustion chamber 17 of the cylinder 13 via an injection valve 16. To this end, fuel is supplied to the injection valve via a fuel supply 18, via which fuel is provided in a manner known per se (e.g., common rail) under a high fuel pressure.

The injection valve 16 has an electromagnetically or piezoelectrically controllable actuator unit 21 coupled to a valve needle 22. In the closed state of the injector valve 6, the valve needle 22 is seated on a needle seat 23. By controlling the actuator unit 21, the valve needle 22 is moved longitudinally and releases a portion of a valve opening in the needle seat 23 in order to inject the pressurized fuel into the combustion chamber 17 of the cylinder 13.

The injection valve 16 further has a piezo sensor 25 arranged in the injection valve 16. The piezo sensor 25 is deformed by pressure changes in the fuel supplied through the injection valve 16 and is generated by a voltage signal as a sensor signal.

The injection takes place in a manner controlled by a control unit 30 which specifies an amount of fuel to be injected by energizing the actuator unit 21. Power is supplied at a specific control time. The sensor signal is sampled over time using an A/D converter 31 in the control unit 30, in particular at a sampling rate of 0.5 to 5 MHz. Doing so results in a signal time series.

Furthermore, a pressure sensor 18 is provided to determine a fuel pressure upstream of the injector 16.

During operation of the internal combustion engine 12, the sensor signal is used to determine a correct opening- or closing time point of the injection valve 16. For this purpose, the sensor signal is digitized using the A/D converter 31 and by specifying an evaluation time window into a corresponding evaluation point time series A (signal time series) and evaluated using the trained, data-based system model, whereby an open duration for the injector valve 16 and, accordingly, an injected quantity of fuel can be determined, depending on the fuel pressure and further operating parameters. To define the open duration, an opening time and a closing time are in particular needed to determine the open duration as the time difference of these variables.

In conjunction with the technical system 2, an input data set may be created from the fuel pressure, the control time, and the sampled voltage signal as a signal time series as a query point and provided to the system model to determine an opening and/or closing time. Fuel pressure and control time variables are state variables and the sampled signal is the signal time series.

To train the system model, the method described above may be applied. By measuring on a test bench, training data sets may be provided that include the fuel pressure, the control time, and the sampled voltage signal as a signal time series and assign a different measured or specific opening and/or closing time to this as a label, e.g., coded as a classification vector (change point timing). To partition the training data sets, the state variables of the fuel pressure and control time may be used.

1. A computer-implemented method for training a data-based system model, comprising:
providing training data sets for training the system model, wherein the training data sets each comprise an input data set and a label;
training the system model using at least some of the training data sets;
executing a method for clustering data points in the input data sets in order to obtain data point clusters;
determining a cluster model quality for each cluster, wherein the cluster model quality indicates an accuracy of the trained system model at the cluster data points with regard to the label assigned to the data points;
depending on the cluster model quality of each cluster, providing additional training data for the relevant cluster; and
further training the system model using the additional training data.

2. The method according to claim 1, wherein the system model is provided as a neural network or as a data-based probabilistic regression model.

3. The method according to claim 1, wherein the input data sets comprise at least one signal time series, wherein the clustering method is performed on data points of the input data sets which are determined at least by the at least one signal time series of the input data sets.

4. The method according to claim 1, wherein the clustering method is configured to detect only clusters having a predetermined minimum number of data points as clusters, and wherein the clustering method considers a distribution density of the data points.

5. The method according to claim 1, wherein the clustering method comprises:
creating a neighborhood graph having an edge weighting determined from a predetermined distance metric;
executing a renormalization of the edge weighting in the neighborhood graph according to a local distribution density of the data points;
creating a minimum span tree from the neighborhood graph; and
extracting clusters from the spanning tree to aggregate the data points into clusters.

6. The method according to claim 1, wherein the training data sets are partitioned, wherein the clustering method is performed on the partitioned training data sets separately, wherein partitioning is performed depending on at least one state variable in the input data sets, and wherein partitioning is performed with respect to predetermined value ranges of the at least one state variable and/or the label.

7. The method according to claim 1, wherein determining the cluster model quality for each cluster comprises determining an average value or a median value of differences between the model output of the system model at the data points of the relevant cluster and the labels respectively associated with the data points.

8. A device for performing the method according to claim 1.

9. A computer program product comprising instructions that, when the program is executed by a computer, prompt said computer to carry out the steps of the method according to claim 1.

10. A machine-readable storage medium comprising instructions which, when performed by a computer, prompt the computer to perform the method steps according to claim 1.
